(19) United States
(12) Patent Application Publication
(10) Pub. No.: US 2008/0201477 A1
(43) Pub. Date: Aug. 21, 2008

(54) Client side replacement of DNS addresses

(75) Inventors: James Christopher Gray, Kirkland, WA (US); James Lyon, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/706,520

(22) Filed: Feb. 15, 2007

(51) Int. Cl. G06F 15/16

(52) U.S. Cl. 709/227

(57) ABSTRACT

A DHCP response is intercepted and the DNS address in the DHCP response is placed with an address for a server device when the server device is present on a local network. When the server device is not present, the DNS address from the DHCP response is used. The server device may provide authentication, shared resources, or other services to devices within a local area network and may also serve as a gateway to other networks including the Internet.

### BACKGROUND

Dynamic Host Configuration Protocol (DHCP) is a set of rules used by a communications device such as a computer, router or networking adapter to allow the device to request and obtain an Internet address from a server which has a list of addresses available for assignment. Part of a DHCP request is a request for a Domain Name Server (DNS), which is a device that can direct network requests to the appropriate device to respond.

When a computer or other device connects to a network, it may send out a broadcast DHCP request over the network to request various parameters, including a network IP address, subnet mask, a DNS server, and a default gateway. When a user connects a mobile device, such as a laptop computer to a home network, the DHCP settings would be different than when the same device is connected to a network at an office.

### SUMMARY

When a server device is present on a local network in addition to a DHCP server, a DHCP response is intercepted and the DNS address in the DHCP response is replaced with an address for the server device. When the server device is not present, the DNS address from the DHCP response is used. The server device may provide authentication, shared resources, or other services to devices within a local area network and may also serve as a gateway to other networks including the Internet.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a network with a DHCP server and a local server.

FIG. 2 is a flowchart illustration of an embodiment showing a method for changing DNS addresses when a server is present.

FIG. 3A is a timeline illustration of an embodiment showing a configuration sequence with a broadcast server message.

FIG. 3B is a timeline illustration of an embodiment showing a configuration sequence with a broadcast server request.

FIG. 3C is a timeline illustration of an embodiment showing a configuration sequence with a server auto-detection of a DHCP request.

FIG. 3D is a timeline illustration of an embodiment showing a configuration sequence with no server present.

FIG. 4 is a diagram illustration of an embodiment of a software architecture incorporating a filter driver.

### DETAILED DESCRIPTION

Some networks may be configured with a server device that provides various services across several devices on a local area network. In order to route network communications through the server for proper handling, the DNS entry in a DHCP response is intercepted and replaced with an address for the server device. The interception is done on a client device and when a server device is detected on the network.

The interception is performed on a client device and is useful for devices that are frequently reconnected to different networks. When connecting to a home network with shared folders administered through a server, the DNS will be set to an address for the server. When the same device is connected to a public network that does not have a server device, the DNS supplied by the DHCP server will be used. The user may not have to perform any setup or change any settings, as the client device may detect the presence of the server and perform the connection to the network properly.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

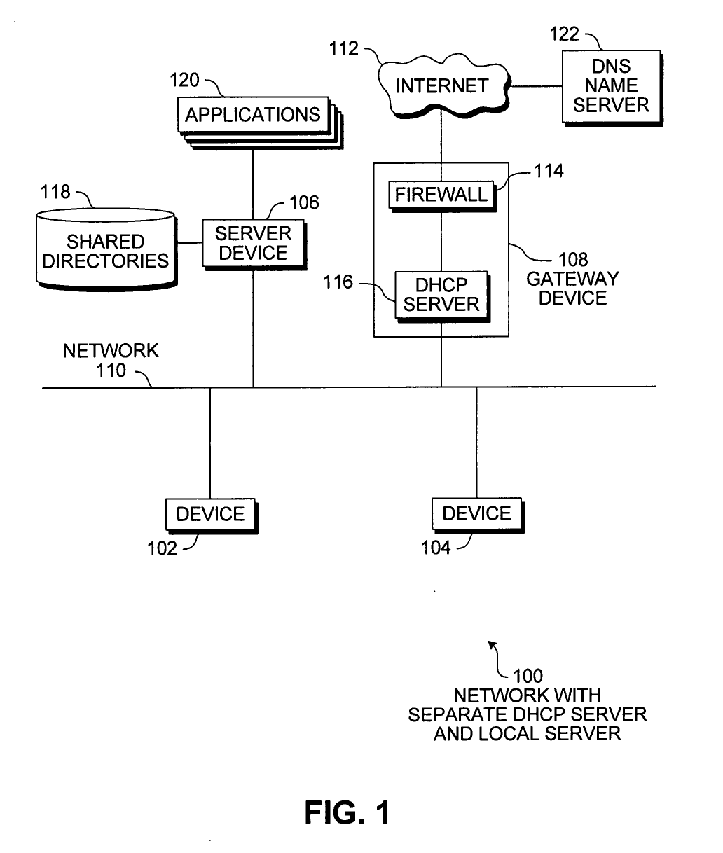

FIG. 1 is a diagram of an embodiment 100 showing a network with a separate DHCP server and a local server. The devices 102 and 104, along with server device 106 and gateway device 108 are all connected to a network 110. The gateway device 108 connects the network 110 to the Internet 112 or other wide area network and may provide firewall services 114 amongst other services.

When a device 102 connects to the network 110, the device may send a broadcast Dynamic Host Configuration Protocol (“DHCP”) request packet that may request, among other things, a network address such as an Internet Protocol (“IP”) address, a default router, subnet mask, and IP addresses for Domain Name Service name server (“DNS”), such as the DNS name server 122. In general, the request is sent to a DHCP server 116 connected to the network 110 that may be a subsystem or service within a device such as the gateway device 108. The DHCP server 116 will return information so that the device 102 may be able to communicate throughout the network and connect to the Internet 112, among other things.

However, when a server device 106 is present on the network 110, it may be useful to have the DNS address on the device 102 or 104 to be the address of the server device 106. By using a DNS address for the server device 106, several different services may be provided through the server device 106. For example, some shared directory systems 118 may be enabled when the DNS setting of a client device 102 and 104 are set to route DNS requests through the server device 106. Additionally, various applications 120 may be enabled, such as internet monitoring software, caching applications, various authentication, authorization, and accounting applications, as well as other applications.

In a typical example, a user may have a device 104 that is a laptop computer connected to the network 110 that has a server device 106. The device 104 may be configured to detect that the server device 106 is present and use a DNS address supplied by the server device 106 rather than a DNS address supplied by the DHCP server 116. When the device 104 is disconnected from the network 110 and connected to a different network without a server device, the device 104 may use the DHCP-supplied DNS address.

In the example, the device 104 may be adapted to discover the server device 106 at some point before, during, or after the configuration of the laptop computer. The discovery may be an active discovery where the device 104 may send out a query on the network 110, to which the server device 106 may respond with a message and a DNS address. In other embodiments, the discovery may be more passive where the server device 106 may send out periodic broadcast messages or where the server device 106 may detect and respond to a DHCP request with a message and a DNS address. Various embodiments may perform the discovery of a server device 106 on the network 110 in different manners and sequences.

In some embodiments, a device 102 or 104 may discover the server device 106 on the network 110 after configuring to the DHCP-supplied DNS address. In such embodiments, the device 102 or 104 may change an internal DNS setting to that of the server device 106 after an initial configuration is established.

In many systems, a DHCP server 116 may be difficult for a user to configure, especially a novice user. The gateway device 108 may be a pre-configured device such as a cable modem, DSL modem, or other network appliance. By having each device 102 and 104 determine if a server 106 is present on the network 110, DNS addresses within the local network may be properly assigned without having to make changes to the gateway device 108. Further, because each device 102 and 104 may detect the presence of the server device 106, the configuration of the DNS address may be set to the DHCP server settings when the server device 106 is offline or otherwise unavailable on the network 110. This situation may allow a device 102 or 104 to function on the network 110, albeit without the various services of the server device 106.

In a typical embodiment, when the DNS address in the network configuration of device 102 is changed to that of the server 106, some requests may require the DNS name server 122, such as requests sent to devices over the Internet 112. Such requests would be routed to the server device 106 then to the DNS name server 122. The intermediate step of routing a request through the server 106 may enable various monitoring and other applications 120 to act on such requests generated across the network 110.

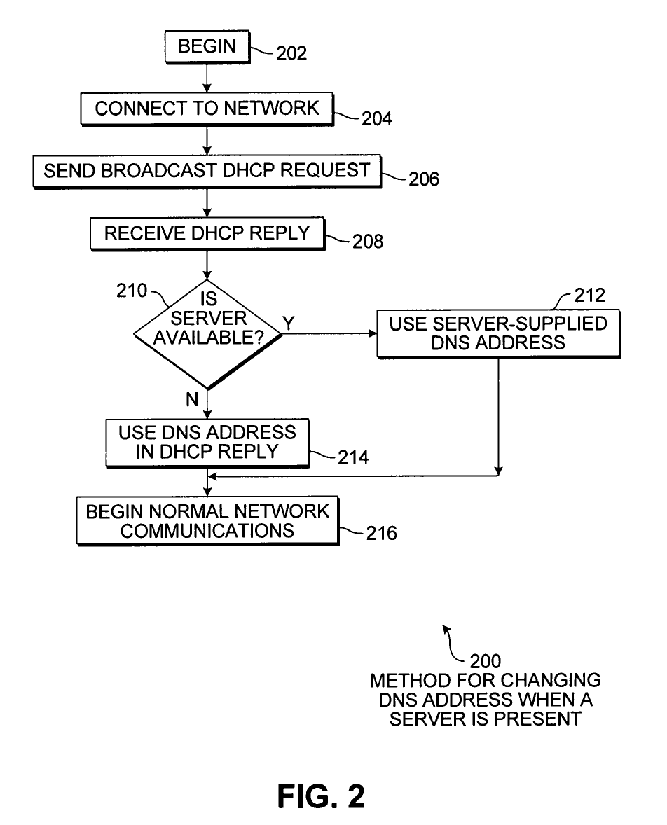

FIG. 2 is a flowchart illustration of an embodiment 200 showing a method for changing a DNS address when a server is present. The process begins in block 202. A device connects to a network in block 204 and sends a broadcast DHCP request in block 206 over the network, to which a reply is received in block 208.

If a server is available in block 210, a server-supplied DNS address is used in block 212 to configure the device. If a server is not available in block 210, a DNS address in the DHCP reply is used in block 214. Normal network communications are begun in block 216.

The embodiment 200 is but one example of a method for using a DNS address supplied by a server device that is not the DHCP server. When a server is detected in block 210, a DNS address supplied by the server may be used instead of a DNS address supplied by a DHCP server.

Various mechanisms may be used to detect whether a server is present. For example, a device may send a broadcast query for a server over a network and wait for a response. In another example, a server may detect that a DHCP request has been issued and the server may send a broadcast or directed response to the device so that the DHCP response and the server response arrive at the device in time for the device to be properly configured. In yet another example, a server may send out periodic broadcast messages announcing its presence.

The embodiment 200 may enable a device to configure itself in one manner when a server is present and in another manner when a server is not present. Such a method may be useful when a DHCP server is difficult to reconfigure to provide a server's DNS address. Another use for the embodiment 200 is to provide a DNS address and thus access to various services available on a server but also provide an alternative configuration when a server is not available on the network.

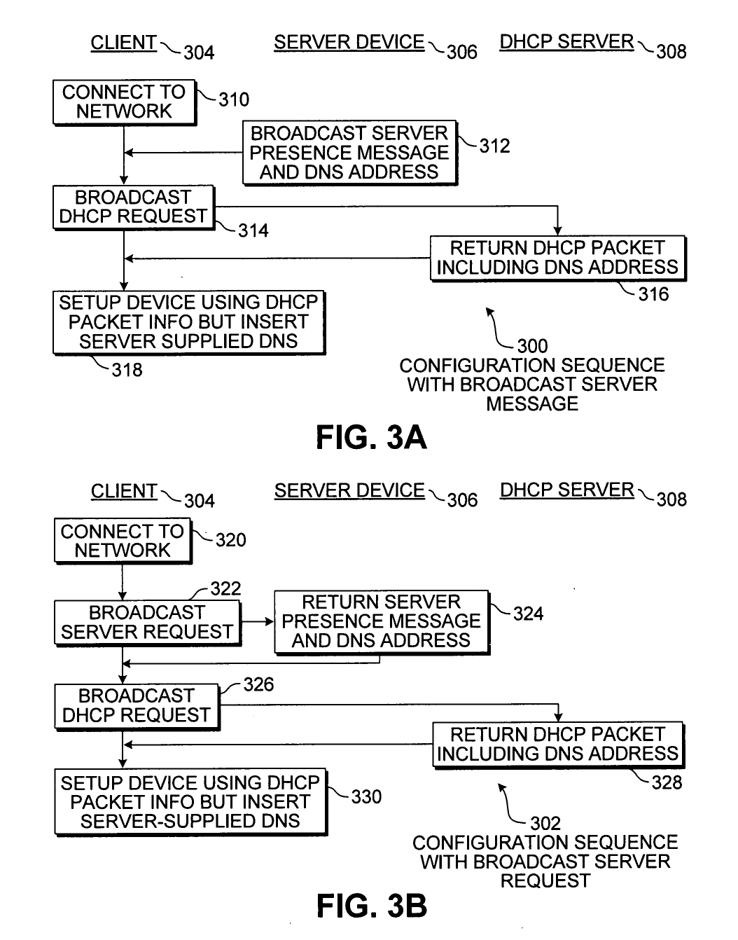

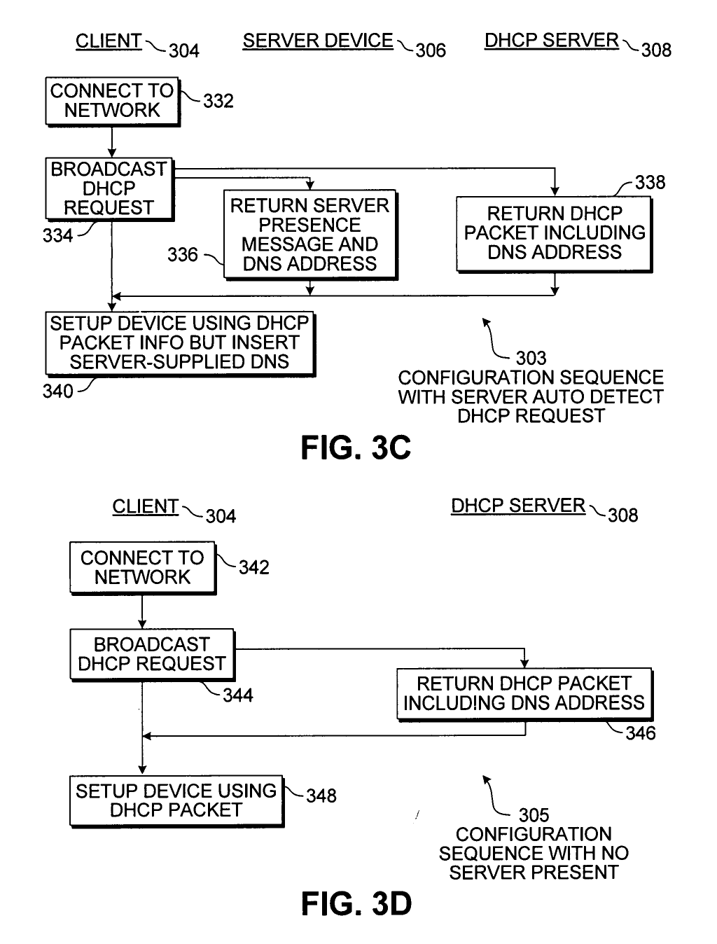

FIG. 3A is a timeline illustration of an embodiment 300 showing a configuration sequence with a broadcast server message. Actions by a client device are shown in the left hand column 304, actions by a server device are shown in the center column 306, and actions by a DHCP server are shown in the right hand column 308. The client connects to a network in block 310. After the client connects to the network, the server device broadcasts a server presence message and a DNS address in block 312.

The client broadcasts a DHCP request in block 314, to which the DHCP server returns a DHCP packet that includes a DNS address in block 316. The client device performs a setup routine using the DHCP packet information but inserting the server-supplied DNS address in place of the DHCP-supplied address in block 318.

Embodiment 300 illustrates a passive mechanism whereby the server device sends out a presence message and DNS address without any prompting by a client device. In some implementations of embodiment 300, the broadcast message in block 312 may be received after the client device has been configured. In such an embodiment, the client device may change a DNS setting after the first configuration has been established. Such a change may occur automatically or a user may be prompted to approve the change.

FIG. 3B is a timeline illustration of an embodiment 302 showing a configuration sequence with a broadcast server request. Actions by a client device are shown in the left hand column 304, actions by a server device are shown in the center column 306, and actions by a DHCP server are shown in the right hand column 308. The client connects to a network in block 320. After the client connects to the network, the client device broadcasts a server presence request in block 322, to which the server device responds with a server presence request and a DNS address in block 324.

The client broadcasts a DHCP request in block 326, to which the DHCP server returns a DHCP packet that includes a DNS address in block 328. The client device performs a setup routine using the DHCP packet information but inserting the server-supplied DNS address in place of the DHCP-supplied address in block 318.

Embodiment 302 illustrates an active mechanism whereby the client device initiates the discovery of a server device on a network. In some embodiments, the server discovery may be performed before or after the broadcast DHCP request of block 326.

In some embodiments, a client device may wait a period of time for any server device on the network to respond to the broadcast request. After the period of time and if no response has been received, a client device may proceed as if no server is present.

FIG. 3C is a timeline illustration of an embodiment 303 showing a configuration sequence with a broadcast server message. Actions by a client device are shown in the left hand column 304, actions by a server device are shown in the center column 306, and actions by a DHCP server are shown in the right hand column 308. The client connects to a network in block 332. After the client connects to the network, the client broadcasts a DHCP request in block 334.

The server device receives the broadcast DHCP request and returns a server presence message and DNS address in block 336. The DHCP server also receives the broadcast DHCP request and responds with a DHCP packet that includes a DNS address. The client device performs a setup routine using the DHCP packet information but substituting the server-supplied DNS address.

Embodiment,303 is yet another example of a sequence where a client device may perform a setup routine that receives a DNS address from a server other than the DHCP server and uses the server-supplied DNS entry for a configuration.

FIG. 3D is a timeline illustration of an embodiment 305 showing a configuration sequence with a broadcast server message. Actions by a client device are shown in the left hand column 304 and actions by a DHCP server are shown in the right hand column 308. The client connects to a network in block 342 and broadcasts a DHCP request in block 344.

The DHCP server returns a DHCP packet that includes a DNS address in block 346. The client device uses the DHCP packet to perform a setup routine in block 348.

Embodiment 305 is an example of a configuration sequence when a server device is not present. Because no server is present, the DNS address contained within the DHCP packet is used to configure a client device.

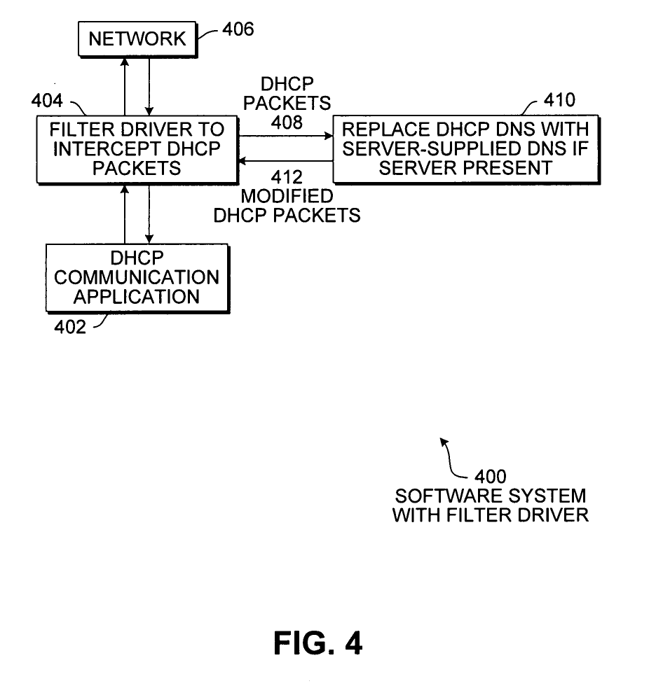

FIG. 4 is a diagram illustrating an embodiment 400 showing a software system using a filter driver to intercept and configure DHCP packets. A DHCP communication application 402 makes requests for and processes DHCP packets for setting up a device on a network. The DHCP communication application 402 communicates through a filter driver 404 to communicate with devices on a network 406. The filter driver 404 intercepts DHCP packets from the network 406, transfers the packets 408 to a routine 410 that replaces a DHCP DNS address with a server-supplied DNS if a server is present. The routine 410 transfers back a modified DHCP packet 412 that is passed to the DHCP communication application 402.

The filter driver 404 may check all incoming packets to determine if an incoming packet is a DHCP packet. Rather than passing the incoming DHCP packet directly to the DHCP communication application 402, the filter driver 404 may redirect the DHCP packet 408 and pass the modified DHCP packet 412 to the DHCP communication application 402. In this manner, the filter driver 404 may be installed in a system without any changes to the DHCP communication application 402.

Embodiment 400 is but one example of an architecture for implementing a routine to modify a DHCP server's DNS setting with that of another server device. By using a filter driver 404, the functionality may be implemented without changing the DHCP communication application. The DHCP communication application may process an incoming packet normally, even though the packet had been intercepted and changed by the routine of block 410.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
detecting a presence of a server device, said server having a server address;
when said server device is present:
sending a DHCP request;
receiving a DHCP reply comprising a DNS entry;
changing said DNS entry to said server address; and
setting a DNS lookup address to said server address;
when said server device is not present:
sending a DHCP request;
receiving a DHCP reply comprising a DNS entry; and
setting a DNS lookup address to said DNS entry.

2. The method of claim 1, said presence being determined by sending a broadcast server request.

3. The method of claim 1, said presence being determined by receiving a server presence message.

4. The method of claim 3, said server presence message being a broadcast message.

5. The method of claim 1, said server device providing access to at least one shared resource.

6. The method of claim 1, said server device providing at least one of a group composed of authorization services, authentication services, and accounting services.

7. A computer readable medium comprising computer executable instructions adapted to perform the method of claim 1.

8. A client device comprising:
a network interface;
a controller adapted to detect if a server device is present on said network and perform a method comprising steps of:
when said server device is present:
sending a DHCP request;
receiving a DHCP reply comprising a DNS entry;
changing said DNS entry to said server address; and
setting a DNS lookup address to said server address;
when said server device is not present:
sending a DHCP request;
receiving a DHCP reply comprising a DNS entry; and
setting a DNS lookup address to said DNS entry.

9. The client device of claim 8, said presence being determined by sending a broadcast server request.

10. The client device of claim 8, said presence being determined by receiving a server presence message.

11. The client device of claim 10, said server presence message being a broadcast message.

12. The client device of claim 8, said server device providing access to at least one shared resource.

13. The client device of claim 8, said server device providing at least one of a group composed of authorization services, authentication services, and accounting services.

14. A method comprising:
connecting to a server device to a network with a client device;
installing a client filter driver on said client device, said client filter driver being adapted to:
detect if said server device is present on said network;
when said server device is present:
sending a DHCP request;
receiving a DHCP reply comprising a DNS entry;
changing said DNS entry to said server address; and
setting a DNS lookup address to said server address;
when said server device is not present:
sending a DHCP request;
receiving a DHCP reply comprising a DNS entry; and
setting a DNS lookup address to said DNS entry.

15. The method device of claim 14, said presence being determined by sending a broadcast server request.

16. The method device of claim 14, said presence being determined by receiving a server presence message.

17. The method device of claim 16, said server presence message being a broadcast message.

18. The method device of claim 14, said server device providing access to at least one shared resource.

19. The method device of claim 14, said server device providing at least one of a group composed of authorization services, authentication services, and accounting services.

20. A computer readable medium comprising computer executable instructions adapted to perform the method of claim 14.
